(19) United States
(12) Patent Application Publication
(10) Pub. No.: US 2026/0117579 A1
(43) Pub. Date: Apr. 30, 2026

(54) A WINDOW UNIT FOR A BUILDING OR STRUCTURE

(71) Applicant: ClearVue Technologies Ltd, West Perth (AU)

(72) Inventors: Douglas John Charles HUNT, West Perth (AU); Victor ROSENBERG, West Perth (AU)

(73) Assignee: ClearVue Technologies Ltd, West Perth (AU)

(21) Appl. No.: 19/118,724

(22) PCT Filed: Oct. 6, 2023
(86) PCT No.: PCT/AU2023/050971

§ 371 Date: Apr. 4, 2025

(30) Foreign Application Priority Data
Oct. 6, 2022 (AU) 2022902915
Dec. 23, 2022 (AU) 2022904008
Feb. 14, 2023 (AU) 2023900352

(51) Int. Cl. E06B 3/667; E06B 3/663; E06B 9/24; H02S 20/22; H02S 40/34

(52) U.S. Cl. CPC E06B 3/667; E06B 3/66352; H02S 20/22; H02S 40/34; E06B 9/24

(57) ABSTRACT

An embodiment provides a window unit corner spacer for spacing apart first and second window panels in a window unit. The corner spacer may comprise a corner spacer body having a recess that is dimensioned to receive a solar cell, and a first coupling portion and a second coupling portion each extending from the body. The corner space may also include a first electrical connector positioned in the recess for electrically connecting the solar cell that is received in the recess to one or more electrical components. The corner space may also include a spacer coupler coupled to or formed with the body. The spacer coupler may be configured to be received in and couple to one or more spacer portions that space apart the first and second window panels, wherein, in use, a primary seal that prevents transfer of a gaseous medium, such as air, if formed between at least the spacer coupler and the first and second window panels.

### CROSS-REFERENCE TO RELATED APPLICATIONS

This application is a U.S. national phase application of International Application No. PCT/AU2023/05097 filed Oct. 6, 2023, which claims benefit of priority to AU 2022902915, filed on Oct. 6, 2022, AU 2022904008, filed on Dec. 23, 2022, and AU 2023900352, filed on Feb. 14, 2023, the contents of which are incorporated herein by reference in their entireties.

### FIELD OF THE INVENTION

The present disclosure relates to a window unit for a building or structure and relates particularly to a window unit comprising solar cells.

### BACKGROUND OF THE INVENTION

Buildings such as office towers, high-rise housings and hotels use large amounts of exterior window panelling and/or facades which incorporate glass panelling.

Such glass panelling receives large amounts of sunlight, which results in heating of interior spaces requiring the use of air conditioners. The sunlight received by the glass panelling could at least partially be used absorbed by solar cells to generate electricity.

PCT international applications numbers PCT/AU2012/000778, PCT/AU2012/000787 and PCT/AU2014/000814 (owned by the present applicant) disclose window units having a windowpane which is transmissive for visible light, but comprise solar cells that absorb light, such as infrared radiation, to generate electricity.

Further, windows of buildings may comprise other electric components such as components regulating the transmission of light which often require control electronics. The windows may be sealed units and electric components such as solar cells may be located within sealed spaces. Positioning control electronics and providing electric connections to such electric components can be challenging.

The present disclosure may provide an embodiment with further improvement.

### SUMMARY OF THE INVENTION

An embodiment provides a window unit corner spacer for spacing apart first and second window panels in a window unit, the corner spacer comprising:
a corner spacer body having a recess that is dimensioned to receive a solar cell;
a first coupling portion and a second coupling portion each extending from the body, the first and second coupling portions configured to be received in and couple to an elongated side support that in use support one or more solar cells;
a first electrical connector positioned in the recess for electrically connecting the solar cell that is received in the recess to one or more electrical components; and
a spacer coupler coupled to or formed with the body, the spacer coupler configured to be received in and couple to one or more spacer portions that space apart the first and second window panels, wherein, in use, a primary seal that prevents transfer of a gaseous medium, such as air, if formed between at least the spacer coupler and the first and second window panels.

The spacer coupler may have opposed sides that in use are each bonded to one of the first or second window panel. The opposed sides may be textured such that sealant applied to the texture bonds and flows similarly to sealant applied to the spacer portions. The spacer coupler may be provided with a spacer coupler body and coupling elements extending from the spacer coupler body. The coupling elements may be configured to be received in and couple to one of the spacer portions. The coupling elements may be coupleable to the spacer coupler body. The coupling elements may be provided with a dovetail pin and the spacer coupler body is provided with a channel having a complementary shape that can receive the dovetail pin such that an interference fit is formed therebetween to lock the dovetail pin and channel together.

The first coupling portion and the second coupling portion may extend away from the corner spacer body in a direction transverse one another, such as at 90°. The first coupling portion and the second coupling portion may each be provided with elongate projections that provide an interference fit with the elongated side support. The elongate projections may extend from the corner spacer body along a longitudinal direction of the first coupling portion and the second coupling portion. The first coupling portion and the second coupling portion may each comprise a plurality of coupling portions. The recess may be provided with a locator that in use locates the solar cell into a correct orientation whereby a terminal of the solar cell is aligned with the first electrical connector for sliding engagement thereto. The locator may be provided on a sidewall of the recess. The locator may be positioned in the recess proximate to the first electrical connector.

The recess may be positioned on a right side of the corner spacer body such that the recess runs at or along a right side of the corner spacer body. The recess may be positioned on a left side of the corner spacer body such that the recess runs at or along a left side of the corner spacer body. The spacer coupler may include an electric feedthrough for directing electricity between at least a solar cell electrically connected to the first electrical connector and an electric component positioned outside the window unit. The electric feedthrough may be sealed in a manner such that a transfer of a gaseous medium, such as air, through the corner spacer with the electric feedthrough is avoided.

The first electrical connector and a second electrical connector may be arranged such that one or more solar cells associated with a first elongated side support engaged with the first coupling portion can engage with the first electrical connector and the second electrical connector. A third electrical connector and a fourth electrical connector may be arranged such that one or more solar cells associated with a second elongated side support engaged with the second coupling portion can engage with the third electrical connector and the fourth electrical connector. The first electrical connector and the fourth electrical connector may be electrically connected together and the second electrical connector and the third electrical connector are electrically connected together. The first electrical connector and the second electrical connector may be electrically connected together and to the electric feedthrough. The third electrical connector and the fourth electrical connector may be electrically connected together and to the electric feedthrough separate to the first electrical connector and the second electrical connector.

An embodiment provides a coupling element used to couple together elongated side supports that are positioned in use between first and second window panels in a window unit. In an embodiment, the coupling element may comprise a coupling body having a first side and a second side opposite the first side; a first coupling portion extending from the first side of body in a first direction and a second coupling portion extending from the second side of the body in a second direction opposite the first direction, the first and second coupling portions configured to be received in and couple to separate elongated side support that in use each support one or more solar cells; and a first elongate projection on a lateral side of the first coupling portion and a second elongate projection on a lateral side of the second coupling portion, the first elongate projection and the second elongate projection being configured to form an interference fit with a respective elongated side support.

The coupling element may further comprise a first electrical connector extending from the first side to the second side of the body and a second electrical connector extending from the first side to the second side of the body. The second electrical connector may be electrically isolated from the first electrical connector.

An embodiment provides a window unit spacer system for spacing apart first and second window panels in a window unit. The spacer system may comprise one or more corner spacers as set forth above. The window unit spacer system may further comprise the coupler as set forth above.

An embodiment provides a window unit for a building or structure, the window unit comprising:
first and second panels each having an area transparent for at least a portion of visible light;
the window spacer system as set forth above, wherein one or more elongated side spacer portions and one or more elongated side supports are engaged with the one or more corner spacers, and
wherein the first and second panels are spaced apart are adhered to at least one of the one or more elongated side spacer portions and one or more elongated side supports and the one or more corner spacers such that a cavity is formed between first and second panels.

An embodiment provides a window unit for a building or structure, the window unit comprising:
first and second panels each having an area transparent for at least a portion of visible light; and
a spacer structure positioned at least partially between the first and second panels, the spacer structure comprising elongated side spacer portions and corner spacer portions, the elongated side spacer portions and corner spacer portions together forming the spacer structure which surrounds a space between the first and second panels;
wherein at least one of the elongated side spacer portions and corner spacer portions comprises an electric feedthrough for directing electricity between a first electric component positioned outside the window unit and a second electric component positioned at or within the window unit, the at least one of the elongated side spacer portions and corner spacer portions with the electric feedthrough being sealed in a manner such that a transfer of a gaseous medium, such as air, through the at least one of the elongated side spacer portions and corner spacer portions with the electric feedthrough is avoided.

The electric feedthrough may be hermetically sealed in the at least one of the elongated side spacer portions and corner spacer portions comprising the electric feedthrough.

In one specific embodiment at least one of the corner spacer portions comprises the electric feedthrough.

In one embodiment the first and second panels are coupled to the spacer structure using a sealing adhesive material, such as butyl. Further, a layer of the sealing adhesive may be applied over portions the spacer structure and edge portions of the first and second panels whereby a primary seal is formed and which seals an interior space of the window unit in a manner such that a transfer of a gaseous medium, such as air, the interior space is at least substantially avoided.

Embodiments may have the significant advantage that the primary seal is not broken by the electric feedthrough and the presence of the electric feedthrough consequently does not enable penetration of moisture into the interior space of the window unit thereby facilitating long term sealing properties of the window unit.

The window unit may further comprise a secondary seal, such as a seal formed from a silicone material.

The window unit may comprise the second electric component. The second electric component may be positioned between the first and second panels within the space surrounded by the spacer structure. Alternatively, the second electric component may be applied to or positioned at one of the first and second panels. For example, the second electric component may comprise at least one of a suspended particle device, an electrochromic coating, an electro fluidic material, a liquid crystal device, a polymer-dispersed liquid crystal (PDLC) material and an electrophoretic material.

In one embodiment the second electric component comprises solar cells, such as at least one series of solar cells, positioned between the first and second panels within the space surrounded by the spacer structure.

In one embodiment the spacer structure is formed by coupling the corner spacer portions and the side spacer portions together. The corner spacer portions and the elongated side spacer portions of the spacer structure may be coupled together using any suitable couplings, such as couplings having male and female coupling portions. The corner spacer portions, the elongated side spacer portions and the couplings may be arranged such that transmission of a gaseous medium, such as air, through the coupled elongated side spacer portion and corner spacer portion is avoided.

The spacer structure may also comprise a warm edge spacer, which may be provided in the form of at least one of the side spacer portions.

At least one of the side spacer portions may be formed by extrusion of a polymeric material. For example, the polymeric material may be polyisobutylene (PIB) which forms a thermoplastic material. In this embodiment the side spacer portions may be formed by extruding the polymeric material directly between the first and second panels and onto surfaces of the corner spacer portions.

The at least one of the corner spacer portion and side spacer portion comprising the electric feedthrough may also comprise further electronic and/or electronic components, such as diodes and a battery, a battery charge controller or a capacitor arrangement for storing electricity generated by the solar cells. Further, control electronics for controlling electric components of the window unit may be incorporated into the at least one of the corner spacer portion and side spacer portion comprising the electrical feedthrough.

The at least one of the corner spacer portions and side spacer portions comprising the electrical feedthrough may also form part of a support structure for supporting solar cells.

In a first embodiment at least one of the corner spacer portions comprises the electric feedthrough. The at least one corner spacer portion comprising the electric feedthrough may in this embodiment be formed from a suitable polymeric material. The remaining corner spacer portions may be formed a metallic material such as aluminium or also from a suitable polymeric material. The support structure may comprise elongated side support elements which may be coupled to the corner spacer portions using a suitable coupling, such as a coupling comprising male and female coupling portions. The elongated side support elements may be formed from a metallic material such as aluminium or a suitable polymeric material. The elongated side spacer portions, also coupled to the corner spacer portions, may in this embodiment also be formed from a metallic material such as aluminium or a suitable polymeric material and may be separate from, coupled to or form part of respective elongated side support elements.

In a second embodiment at least one of the side spacer portions comprises the electric feedthrough. The at least one side spacer portion comprising the electric feedthrough may be formed from a suitable polymeric material. The remaining side spacer portions may be formed a metallic material such as aluminium or a suitable polymeric material. Further, the corner spacer portions may be formed from a suitable polymeric material or from a metallic material such as aluminium. The support structure may comprise elongated side support elements which are coupled to the corner spacer portions using a suitable coupling, such as a coupling comprising male and female coupling portions. The elongated side spacer portions may be separate from, coupled to or form part of respective elongated side support elements.

The corner spacer portions and the elongated side support elements may comprise recesses and/or grooves for receiving portions of the solar cells.

The window unit may have side or edge portions and at each side or edge portion one, two or three strips of solar cells may be supported by the support structure.

The solar cells may be positioned parallel to a major surface of the first panel. Alternatively, the support structure may be arranged such that at least one strip of solar cells is positioned at an angled orientation relative to the major surface of the first panel. The support structure may be arranged such that solar cells of the at least one strip of solar cells are inclined at an angle smaller than 90°, smaller than 70°, smaller than 50°, smaller than 30° or smaller than 10°.

In one embodiment the spacer structure and the support structure are positioned entirely between the first and second panels. The support structure and the strips of solar cells may be positioned along edges of the first and/or second panel and around a central rectangular area that is free from solar cells.

The spacer structure may be a first spacer structure and the window unit may comprise a second spacer structure. Further, the window unit may comprise a third panel which may be positioned parallel the first and second panels and may be spaced apart from the second panel by the second spacer structure. The second spacer structure may be positioned at least partially between the second and third panels and may comprise elongated side spacer portions and corner spacer portions, the elongated side spacer portions and corner spacer portions being coupled together to form the second spacer structure which surrounds a space between the second and third panels. In this embodiment the second and third panels are coupled to the second spacer structure using a sealing adhesive material, such as butyl. The first panel is in this embodiment also coupled to the second panel via the first spacer structure using a suitable adhesive, such as butyl. Further, a layer of the sealing adhesive may be applied over portions the first and second spacer structure and edge portions of the first, second and third panels whereby a primary seal is formed and which seals interior spaces (between the first and second panel and between the second and third panel) of the window unit in a manner such that a transfer of a gaseous medium, such as air, the interior spaces is at least substantially avoided. The window unit may further comprise a secondary seal, such as a seal formed from a silicone material.

A first edge area of the first panel may extend beyond a projection of the circumference of the second panel in a direction of a surface normal of the first panel.

The first panel may also comprise first and second component panel portions which are bonded together in a manner such that an airgap between the first and second component panel portions is avoided and a laminated structure is formed. At least one series of solar cells may be sandwiched between the first and second component panel portions and may be embedded within an adhesive material, such as polyvinyl butyral (PVB). The solar cells of the at least one series of solar cells may be bifacial solar cells and may be arranged in an overlapping “shingled” arrangement.

The first component panel portion may have a first major surface which is parallel to a first major surface of the second component panel portion, the first major surface of the second panel may have a surface area smaller than an area of the first major surface of the first component panel portion whereby the first and second component panel portions are arranged such that a projection of the first component panel portion along a surface normal of the first component panel portion extends beyond a circumference of the second component panel portion.

The solar cells are typically silicon-based, but may alternatively also comprise CuInSe₂, CIGS or CIS, GaAs, CdS or CdTe.

The window unit may be arranged such that a central area of the window unit is transparent for at least the majority of visible light is at least 5, 10, 15, 20, 50, 100 or even 500× larger than an area of the panel at which the series of the solar cells are positioned. The central area of the window unit may be a rectangular area and may comprise 70%, 80, 90% or more of a surface area of a major surface of the first panel. The central area that is transparent for at least the majority of visible light may be transmissive for at least 60%, 70%, 80%, 90% or even at least 95% or visible light incident of the receiving surface at normal incidence.

The disclosure will be more fully understood from the following description of specific non-limiting embodiments. The description is provided with reference to the accompanying non-limiting drawings.

### BRIEF DESCRIPTION OF THE DRAWINGS

FIG. 1 is a schematic top view of a window unit in accordance with an embodiment of the present disclosure; and

FIGS. 2-11 show components of the window unit in accordance with embodiments of the present disclosure.

FIGS. 12-15 show an embodiment of a corner spacer.

FIG. 16 shows a perspective of another embodiment of a corner spacer.

FIG. 17 shows a perspective view of an embodiment of a coupler.

### DETAILED DESCRIPTION OF EMBODIMENTS

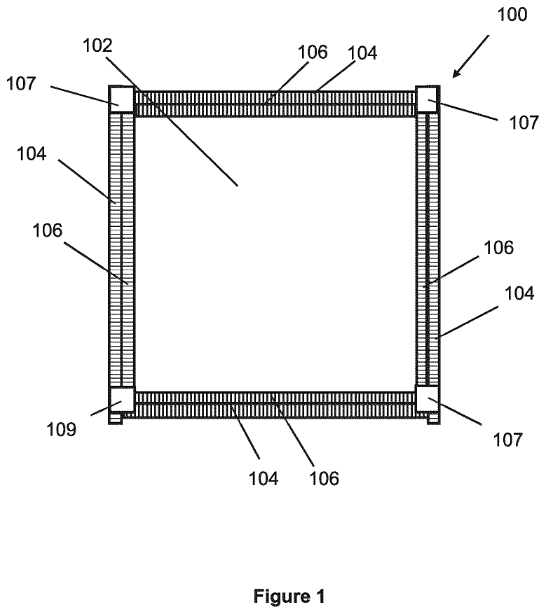

Referring initially to FIG. 1, a window unit according to an embodiment is now described. The window unit 100 may for example be provided in the form of a window of a building, a sky light, a window of a car or any other structure that usually comprises windows.

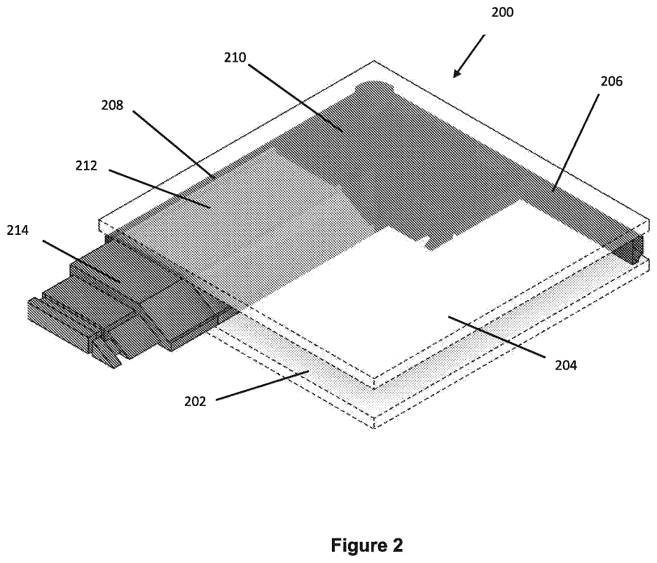

FIG. 1 is a top view of the window unit 100. The window unit 100 comprises a first panel 102 which is parallel to a second panel. The first panel 102 and second panel each have an area transparent for at least a portion of visible light. In this embodiment two strips of solar cells 104 and 106 are positioned adjacent each side spacer portion of the panel 102. The window unit 100 comprises a spacer structure which spaces the first panel 102 from the second panel and a support structure for supporting the strips of solar cells 104, 106. The spacer and support structures comprise corner spacer portions 107, 109 and will be described further below with reference to FIGS. 2-10. The corner spacer portion 109 comprises an electric feedthrough and solar cells of the strips of solar cells 104, 106 are electrically connected to the electric feedthrough such that generated electricity can be accessed through the electric feedthrough.

The spacer structure, the first panel 102 and the second panel define an inner space in which the solar cells 104, 106 are positioned or in which further electric components are positioned. The first and second series of solar cells 104, 106 are positioned around a central area of the first panel which is 80%, 90% or even more transmissive for visible light. The window unit 100 may also comprise another electric or electronic component which may be applied to, or positioned at, one of the first panel 102 or the second panel. For example, the window unit may comprise an electrochromic coating, an electro-fluidic material, a liquid crystal device or and polymer-dispersed liquid crystal (PDLC) material and an electrophoretic material. Alternatively, other electric components, such as blinds, may be positioned between the first panel 102 and the second panel.

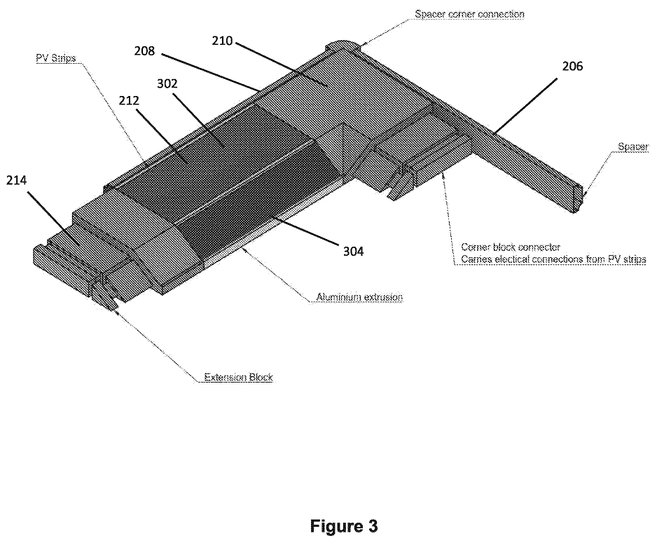

Referring now to FIGS. 2 and 3, components of a window unit 200 in accordance with an embodiment are described in further detail. FIGS. 2 and 3 illustrate an embodiment in which the window unit 200 is a double-glazed window unit comprising a first panel 202 and a second panel 204. The first panel 202 and the second panel 204 are formed from a suitable glass, such as low iron glass. The window unit 200 comprises a spacer structure which has elongated side spacer portions 206 and 208 and spaces the first panel 202 from the second panel 204. The elongated side spacer portions 206 and 208 are coupled to corner spacer portions, such as the corner spacer portion 210 shown in FIGS. 2 and 3.

The side spacer portions 206, 208 are in this embodiment formed from aluminium (such as by aluminium extrusion) and the corner spacer portions are formed from a polymeric material.

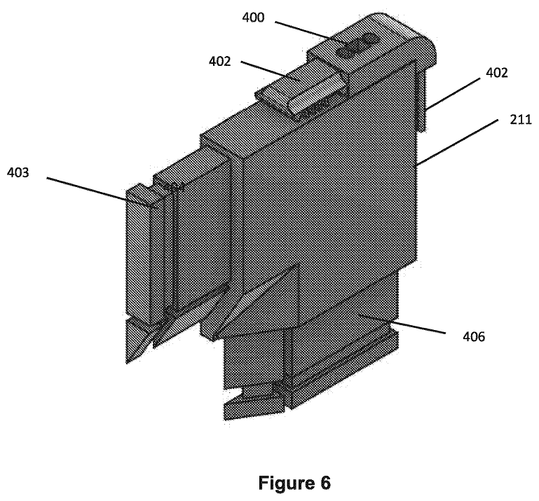

The window unit also comprises in this embodiment one corner spacer portion 211 (not shown in FIGS. 2 and 3) which has an electric feedthrough. The corner spacer portion 211 with the electric feedthrough is arranged to establish an electric connection between an electric component outside of the window unit 200 and the solar cells or other electric components within the interior space of the window unit 200. The corner spacer portion 211 may further comprise additional electronic components or electric components, such as diodes and a battery, a battery charge controller or a capacitor arrangement for storing electricity generated by the solar cells. Further, control electronics for controlling electric components of the window unit (such as an electrochromic coating, an electro-fluidic material, a liquid crystal device or and polymer-dispersed liquid crystal (PDLC) material and an electrophoretic material) may be incorporated into the corner spacer portion. The corner spacer portion 211 and will be described further below with reference to FIG. 6. The window unit 200 comprises three further corner spacer portions 210. One of the corner spacer portions 210 is shown in FIGS. 2 and 3.

The window unit 200 also comprises a support structure for supporting strips of solar cells. The support structure comprises elongated side support elements 212 formed from aluminium by extrusion. The side support elements 212 are coupled to the corner spacer portions 210, 211 using a snap-fit arrangement having male and female portions. In this embodiment the support structure is arranged to support two parallel strips of solar cells 302, 304 along each edge portion of the first and second panels 202, 204. The support elements 212 may include recesses and/or grooves for receiving portions of the solar cells 302 (not shown). The solar cells 302 are oriented parallel to a light receiving surface of the first panel 202 and the solar cells 304 are positioned in an angular orientation relative to the light receiving surface of the first panel 202.

Further, the support structure comprises coupling elements 214 which have two male coupling portions and are arranged to couple together two adjacent elongated side support elements 212.

FIGS. 2 and 3 only illustrate some of the components of the window unit 200. A person skilled in the art will understand that the assembled window unit 200 forms a rectangular structure comprising 3 corner spacer portions 210, one corner spacer portion 211, a plurality of the elongated side support elements 212 and coupling elements 214. Further, the assembled window unit 200 comprises four elongated side spacer portions 206, 208 which are coupled to the corner spacer portions 210, 211.

The first and second panels 202, 204 are coupled to the elongated side spacer portions 206, 208 using a sealing adhesive material, such as butyl and form a primary seal which seals an interior space of the window unit 200 in a manner such that a transfer of a gaseous medium, such as air, is avoided. The window unit 200 further comprises a secondary seal, such as a seal formed from a silicone material, which is applied over an exposed edge of the corner spacer portions 210, 211, exposed portions of the elongated side spacer portions 206, 208, the adhesive material such as butyl (not shown) and edge portions of the first and second panels 202, 204.

A suitable desiccant (not shown) may be placed within the elongated side spacer portions 206, 208 and/or within the elongated side supports elements 212. The elongate portions 206 and 208 may be provided with perforations on an inner surface to allow for transfer of moisture from a cavity in the window unit 200 to the desiccant. In an embodiment, the elongate side spacer portions 206 and/or 208 are spaced from the side support elements 212 such that a gap is formed therebetween. This gap can help allow moisture to be absorbed by the desiccant. In an embodiment, a gap between the spacer portions 206 and/or 208 and the side support elements 212 is about 1 mm to 2 mm, such as about 1 mm.

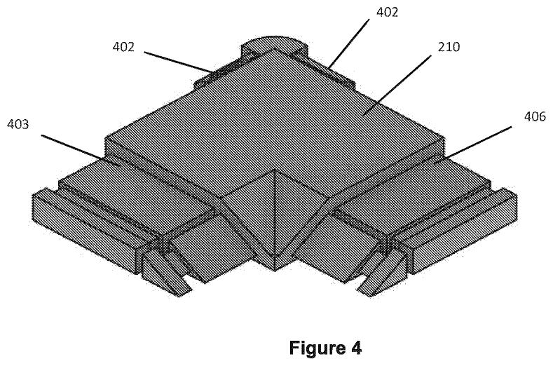

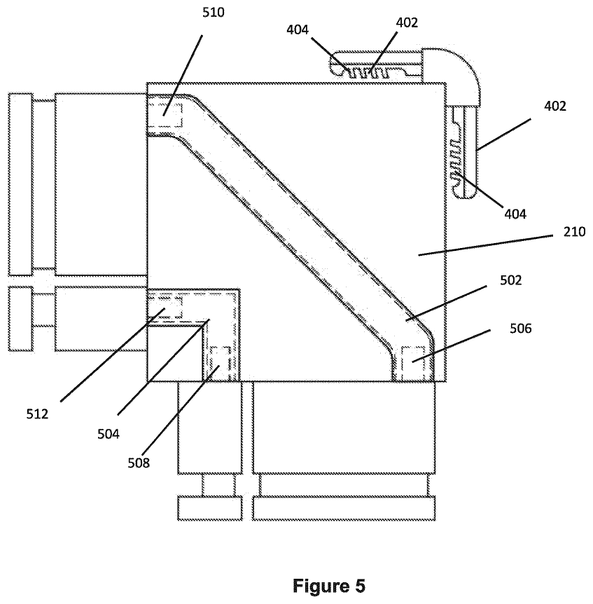

The corner spacer portion 210 is now described in further detail with reference to FIGS. 4 and 5. FIG. 4 shows a perspective view and FIG. 5 is a cross-sectional view of a corner spacer portion 210. In this embodiment the corner spacer portion 210 comprises conductive strips 502, 504 which are formed from copper. The corner spacer portion 210 comprises electrical connectors in the form of sockets 506, 508, 510 and 512 for connecting to strips of solar cells. The conductive strip 502 connects socket 506 with socket 510 and the conductive strip 504 connects socket 508 with socket 512.

The corner spacer portion 210 has projections 402 which are received within hollow end-portions of the elongated side spacer portions 206, 208 shown in FIGS. 2 and 3. The projections 402 are formed from a flexible material and comprise fins or barbs 404, which push against an interior wall portion of the elongated side spacer portions 206, 208 when connected and enable an air-tight connection.

FIG. 6 is a perspective view of the corner spacer portion 211 with a spacer coupler in the form of electric feedthrough 400. The corner spacer portion 211 is related to the corner spacer portion 210 and like components are given like reference numerals. The corner spacer portion 211 with the electric feedthrough 400 is sealed such that transmission of air through the corner spacer portions including the electric feedthrough is avoided. The corner spacer portion 211 with the electric feedthrough 400 may be hermetically sealed. The electric feedthrough 400 is electrically coupled to contacts (not shown in FIG. 6) such as pins or sockets at coupling portions 403, 406, which are positioned to couple to electric contacts of the strips of solar cells.

The electric feedthrough 400 has a terminal 401 for connection to an external electrical system. The properties of the terminal 401 such as size and power capacity may be determined by a voltage generated by a window unit fitted with the electric feedthrough, For example, vision glass tends to have few solar cells compared to spandrel glass, so a voltage output of vision glass tends to be less than that for spandrel glass. Therefore, the terminal 401 can be adjusted depending on the power output of the window unit. The terminal 401 may be a separate component that can be hermetically sealed to the electric feedthrough 400.

The corner spacer portions 210, 211 and the coupling elements 214 may comprise a polymeric material and the side spacer portion 206, 208 may be formed from aluminium. In a variation of the described embodiment the side spacer portions 206, 208 may alternatively be formed by extrusion of a polymeric material directly between the first and second panels. For example, the polymeric material may be polyisobutylene (PIB) which forms a thermoplastic material. The corner spacer portion does in this variation not comprise the projections 402 for coupling to the side spacer portions and polymeric material is extruded directly onto a surface of the corner spacer portions 210 and/or elongated side supports elements 212 from which the projections 402 would otherwise extend.

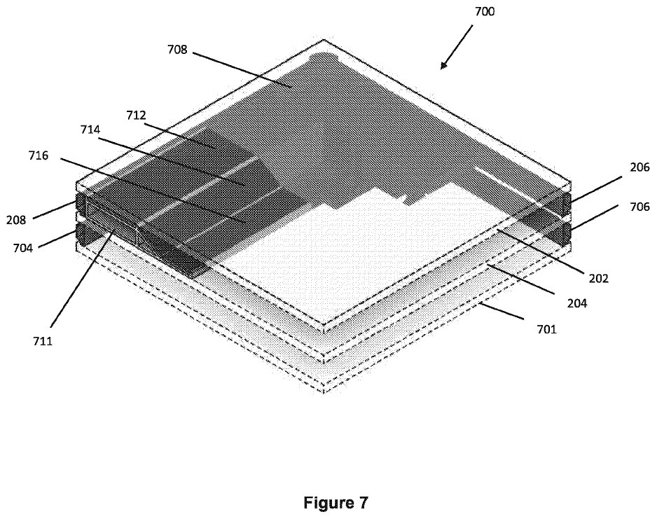

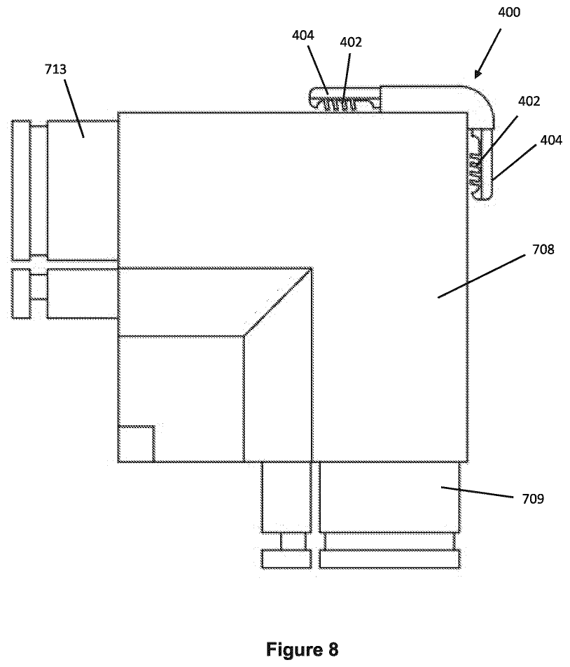

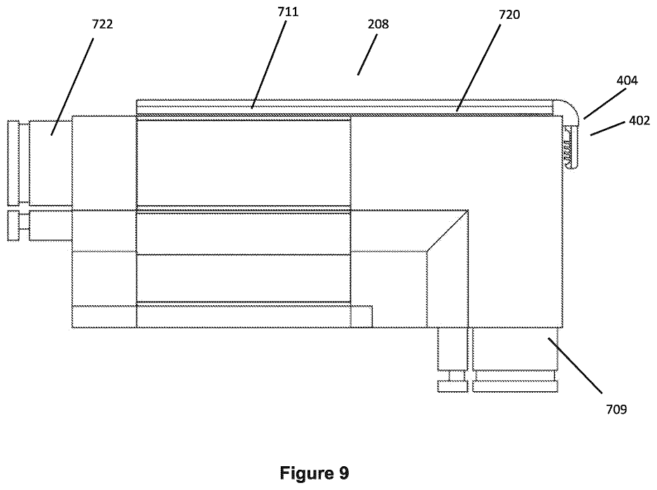

FIG. 7 shows components of a triple-glazed window unit 700 and FIGS. 8, 9 illustrate further components of the window unit 700. Some components of the triple-glazed window unit 700 are related to the components of the double-glazed window unit 200 illustrated with reference to FIGS. 2-6 and like components are be given like reference numerals. In this embodiment the window unit 700 comprises a third panel 701, which is a glass panel formed from low iron glass. The third panel 701 is positioned parallel to the first and second panels 202 and 204. The window unit 700 comprises a second spacer structure, which spaces the third panel 701 from the second panel 204. The second spacer structure comprises elongated side spacer portions 704 and 706, which correspond to side spacer portions 206, 208.

The window unit 700 comprises a corner spacer portion 708, which comprises the electric feedthrough 400. The window unit 700 comprises three further corner spacer portions (not shown) which do in this embodiment not comprise the electric feedthrough 400, but have an exterior shape that is otherwise identical to the corner spacer portion 708. The three further corner spacer portions comprise interior conductive strips which may for example be formed from copper which and connect sockets for coupling to pins of strips of solar cells.

The window unit 700 further comprises elongated side support elements 711, two of which are coupled to the corner spacer portion 708 at coupling portions 709 and 713 when the window unit 700 is assembled. In this embodiment the elongated side support portions 704 and 706 are arranged to support three strips of solar cells 712, 714 and 716 along each edge portion of the window unit 700.

FIG. 8 is a top view of the corner spacer portion 708 with electric feedthrough 400 which is related to the corner spacer portion 211 described above with reference to FIG. 2-6. However, the corner spacer portion 708 is of an increased thickness compared to the corner spacer portion 211 and has additional projections for coupling to the additional elongated side spacer portions 704 and 706. These projections (not shown in FIG. 7) are analogous to the projections 402 of the corner spacer portion 210 and also comprise fins or barbs analogous to the fins or barbs 404 shown in FIG. 5. The projections 402 are formed from a flexible material and comprise fins or barbs 404, which push against an interior wall portion of the elongated side spacer portions 206, 208, 704 and 706 when connected and enable an air-tight connection. The electric feedthrough 400 which is electrically coupled to contacts (not shown) which are positioned to couple to electric contacts of the strips of solar cells 712, 714, 716 shown in FIG. 7.

FIG. 9 is a top view of components of the window unit 700. FIG. 9 shows a corner spacer portion 720 which is related to the corner spacer portion 708 described above, but does not comprise the electric feedthrough 400. Like components are given like reference numerals. The corner spacer portion 720 comprises conductive strips which are formed from copper which and connect sockets for coupling to pins of strips of solar cells. The corner spacer portion 720 also comprises four projections 402 with fins or barbs 404 for coupling to the elongated side spacer portions 206, 208, 704 and 706 shown in FIG. 7. The corner spacer portion 720 comprises coupling portions for coupling to the elongated side support element, such as the elongated side support element 711. Further, FIG. 9 shows a portion of a coupling element 722 for coupling adjacent elongated side support elements together.

The window unit 700 shown in FIG. 7 comprises a plurality of the elongated side support elements 711 (only one elongated side spacer portion is shown in FIG. 7) and adjacent elongated side support elements 711 (also shown in FIG. 9) are coupled together using coupling element 722 (shown in FIG. 9) to form side support elements of increased length. The window unit 700 further comprises the corner spacer portion 708 with the electric feedthrough 400 (shown in FIGS. 7 and 8) and three corner spacer portions 720 without electric feedthrough, one of which is illustrated in FIG. 9. The corner spacer portions 708 and 720 are coupled to the elongated side support elements. The window unit 700 also comprises a plurality of the elongated side spacer portions 206, 208, 704 and 706 which are also coupled to the corner spacer portions 708 and 720 and together with the glass panels 202, 204 and 701 form the window unit 700 comprising primary and secondary seals forms in a manner analogous to the primary and secondary seals of the window unit 200 described above.

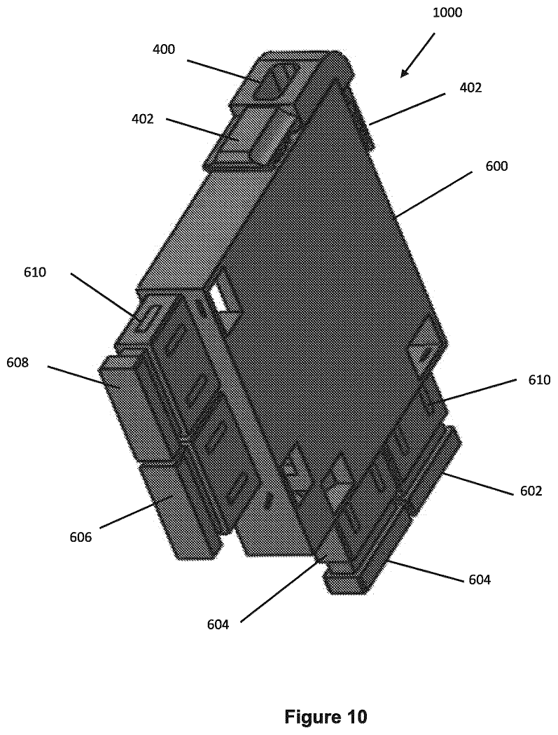

Turning now to FIG. 10, there is shown a schematic perspective view of a corner spacer portion 1000 in accordance with a further embodiment. The corner spacer portion 1000 is related to the corner spacer portion 211 shown in FIG. 6 and like components will be given like references. The corner spacer portion 1000 has projections 402 for coupling to elongated side spacer portions (such as side spacer portions 206,208 shown in FIGS. 2 and 3) which together space apart two glass panels (such as panels 202 and 204 shown in FIG. 2) whereby a gap is formed between the two panels. The corner spacer portion 1000 is in this embodiment arranged for coupling to four elongated side supports elements (not shown, but similar to the side support element 711 shown in FIG. 7) at coupling portions 602, 604, 606 and 608. In this embodiment the side support elements are arranged for receiving parallel strips of solar cells which are positioned in a common plane (not inclined). Each coupling portion 602, 604, 606 and 608 has a plurality of elongated projections 610 which are arranged to engage with an inner surface of a hollow side support element formed from aluminium by extrusion. The coupling portions 602, 604, 606 and 608 are in this embodiment formed from a polymeric material and the projections closely engage with the inner surfaces of the side support elements and the side support surfaces may even “eat into” the projections when inner surfaces of the side support elements slide over the coupling portions whereby a fit with no or very little tolerances is achieved.

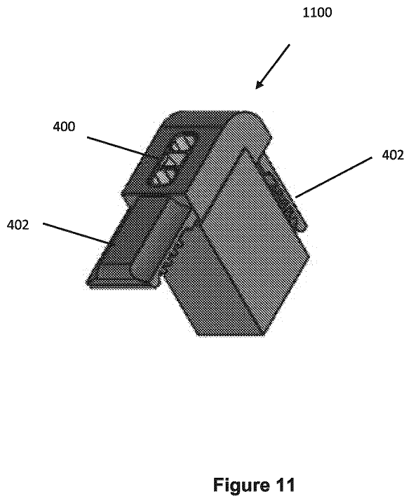

FIG. 11 shows a corner spacer portion 1100 in accordance with another embodiment. Like components are given like reference numerals. The corner spacer portion 1100 is in this embodiment not arranged for coupling to side supports elements for supporting solar cells. However, similar to the corner spacer portion 1000 discussed above, the corner spacer portion 1100 also has projections 402 for coupling to elongated side spacer portions (such as side spacer portions 206, 208 shown in FIGS. 2 and 3) and spacing apart two glass panels whereby a gap is formed between the two glass panels. The corner spacer portion 1100 also has an electric feedthrough 400 and is sealed such that transmission of air through the corner spacer portions including the electric feedthrough is avoided. The electric feedthrough 400 is electrically coupled to an electric component (not shown) which in this embodiment comprises an electrochromic coating. The spacer portion 1100 also control electronic for controlling the electrochromic coating. A person skilled in the art will appreciate that the window unit 100 may instead also comprise another device or coating that controls an optical property of the window unit and may comprise an electro fluidic material, a liquid crystal device or and polymer-dispersed liquid crystal (PDLC) material an electrophoretic material or a suspended particle device.

The window unit comprising the spacer portion 1100 may for example comprise the window panels 202, 204 shown in FIG. 2 and which the corner spacer portion 1100 and the elongated side spacer portions 206, 208 (shown in FIGS. 2 and 3) space from each other.

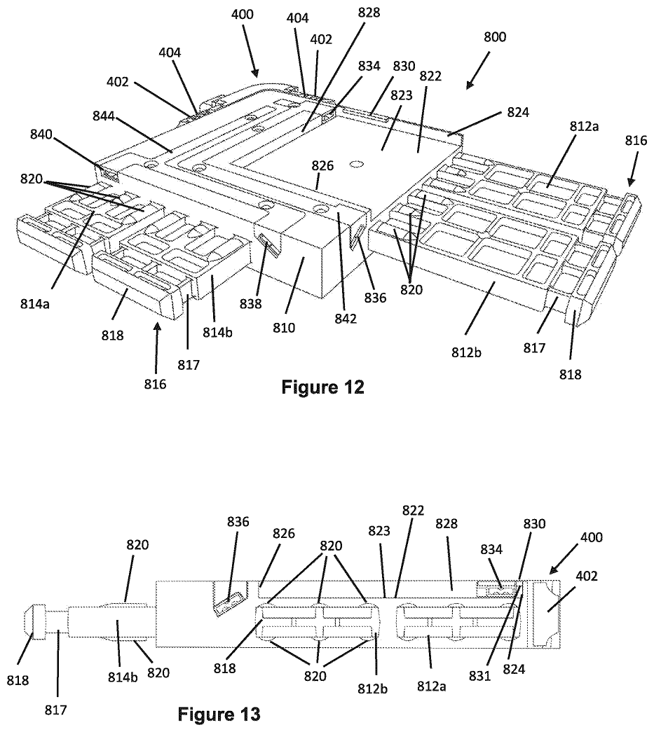

Another embodiment of a corner spacer portion 800 will now be described with reference to FIG. 12 to FIG. 15. The corner spacer portion 800 has a main body 810. Extending from the body 810 is a first coupling portion 812 and a second coupling portion 814. The first coupling portion 812 and second coupling portion 814 each have a longitudinal direction that is transverse to one another. In the embodiment shown in FIG. 12, the first coupling portion 812 and second coupling portion 814 are arranged 90 degrees relative one another.

The first coupling portion 812 has two protrusions 812a and 812b, and the second coupling portion 814 has two portions 814a and 814b. The corner spacer portion 800 is not limited to having two portions for each coupling portion and may have any number. In use, side support elements e.g. 212 are snap-fit to respective first coupling portion 812 and second coupling portion 814. The first coupling portion 812 and the second coupling portion 814 are both provided with a plurality of elongated projections 820 which are arranged to engage with an inner surface of a hollow side support element formed from aluminium by extrusion. The elongate projections 820 help to form an interference fit with the inner surface of the hollow side support element. In an embodiment, the elongate projections 820 are provided on opposed sides (i.e. top and bottom surfaces) of the first coupling portion 812 and the second coupling portion 814, as shown in FIG. 13. In an embodiment, the elongate projections 820 are provided on one of a top or bottom surface of the first coupling portion 812 and the second coupling portion 814 (not shown). In an embodiment, the elongate projections 820 extend from the body 810 along a longitudinal direction of the respective first coupling portion 812 or second coupling portion 814.

The end of each coupling portion 812 and 814 is provided with a locator 816 that helps to locate the coupling portion 812 and 814 in a channel or passage of the hollow side support element. The locator 816 has a head portion 818 and a circumferential channel 817 extending laterally around the coupling portion 812 and 814. In an embodiment, a cross-sectional profile of the head portion 818 is the same as a cross-sectional profile of the respective coupling portion 812 and 814. In an embodiment, a cross-sectional profile of the head portion 818 is larger than a cross-sectional profile of the respective coupling portion 812 and 814.

The body 810 is also provided with a recess 822. The recess 822 is dimensioned to receive a solar cell (not shown). An advantage of the recess 822 is that is increases a surface area of solar cell that can be used with the corner spacer portion 800. The recess 822 has a pair of opposed sidewalls 824 and 826 the extend upwards from a floor 823. In use, a bottom surface of a solar cell rests on the floor 823. The recess 822 also has an end wall 828 that an end face of a solar cell can abut against. A first socket 834 on a first side of the body 810 is electrically connected to a spacer coupler in the form of electric feedthrough 400a that is positioned on the end wall 828. A first side is denoted by the first coupling portion 812, and a second side is denoted by the second coupling portion 814. During installation, a solar cell is slid into the recess 822 such that an electric terminal of the solar cell is received in the socket 834. To assist with guiding the electric terminal of the solar cell into the socket 834, the recess is provided with a locator in the form of tab 830. The tab 830 is arranged such that an underside 831 of the tab 830 urges the solar cell downwards to sit on the floor 823 so that the electric terminal of the solar cell becomes aligned with the socket 834 simply by pushing the solar cell into the recess 822. In an embodiment, the underside 831 of the tab 830 is provided with a tapered or ramped surface to assist with guiding or urging the solar cell down into the recess 822 during installation.

The body 810 is also provided with a second socket 836 on the first side of the body. The second socket 836 is electrically connected to the first socket 834 via conductive strip 842. Conductive strip 842 may be formed from stamped conductive material, such as copper. The conductive strip 842 may be provided with an insulator on its upper surface. The second side of the body 810 has a third socket 848 and a fourth socket 840 that are electrically connected to one another and the electric feedthrough 400a via conductive strip 844. Conductive strip 844 may be formed from stamped conductive material, such as copper. The conductive strip 844 may be provided with an insulator on its upper surface. The conductive strip 844 is separate and electrically isolated from conductive strip 842.

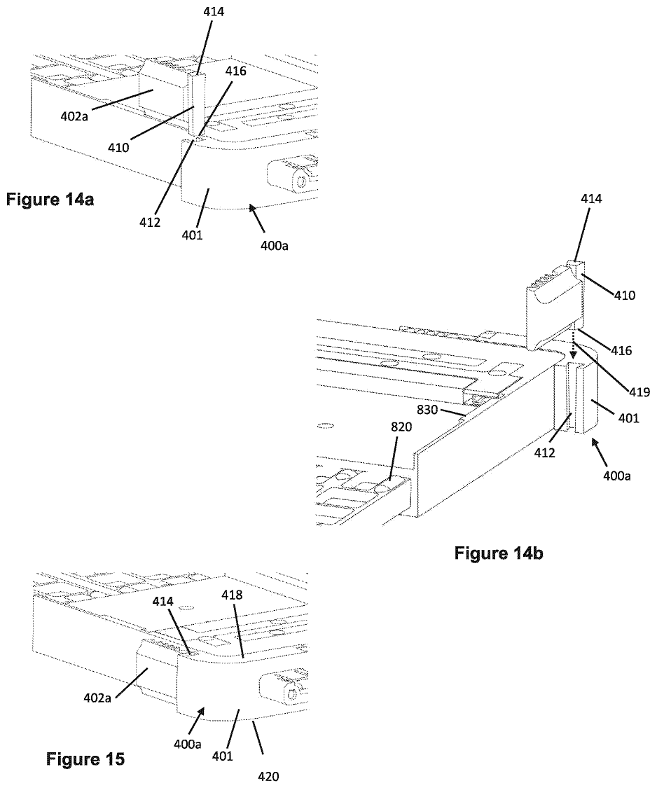

Another embodiment of an electric feedthrough 400a will now be described with reference to FIG. 14a to FIG. 15. The electric feedthrough 400a is similar to electric feedthrough 400 and like features are described with like reference numerals. Unlike electric feedthrough 400, the coupling projections 402a of electric feedthrough 400a are a separate component that is then fitted to a main body 401 of the electric feedthrough 400a. The coupling projections 402a is provided with a dovetail pin 410. In an embodiment, the dovetail pin 410 is tapered such that an upper surface 414 of the dovetail pin 410 is wider than a bottom surface 416. The body 411 is provided with a complementary shaped channel 412 such that the dovetail pin 410 can be received in the channel 412 by sliding the dovetail pin 410 downwards into the channel, as shown by arrow 419, until the upper surface 414 is flush or approximately flush with a top surface 418 of the body 411. Because the dovetail pin is tapered, it forms an interference fit with the channel to be locked thereto. Accordingly, the dovetail pin 410 and channel 412 form a locking tapered sliding dovetail. In an embodiment, the dovetail pin 410 requires tapping into the channel, for example with a hammer, to ensure the dovetail pin is snugly received in channel 412. In an embodiment, during installation the coupling projections 402a is pushed into a side spacer portion 206 and then the dovetail pin 410 is inserted into the channel 412. In an embodiment, during installation the dovetail pin 410 is inserted into the channel 412 and then the coupling projections 402a is pushed into a side spacer portion 206. An advantage of utilising coupling projections 402a is that butyl can be applied to the side spacer portion before a window frame is assembled. This may provide flexibility on how window units are assembled, especially when comparing small and large unit units which may require different assembly conditions.

Instead of using a sliding tapered dovetail, the channel 412 may be provided with a limit stop or similar that limits movement of the dovetail pin 410 in the channel 412. In such embodiments, the dovetail pin 410 may be replaced with a different shape such as rectangular or rounded protrusion.

In an embodiment, the top surface 418 and bottom surface 420 of the body 401 is textured to assist in sealant, such as butyl adhering to the electric feedthrough 400a. The use of the terms “top” and “bottom” are only used in reference to the orientation of the electric feedthrough 400a shown in FIG. 14a to FIG. 15 and does not limit the electric feedthrough 400a to any specific orientation. Top and bottom surface of electric feedthrough 400 may also be similarly textured. The texture may help to ensure that the sealant adheres to the electric feedthrough 400a similar to other components of a window assembly such as the side spacer portion 206 which is typically formed from aluminium. Having a similar sealing property can help to ensure that a consistent amount of sealant is applied to the electric feedthrough 400a to other components when the sealant is applied using an automated sealant applicator that is typically used during high volume manufacture of window frames.

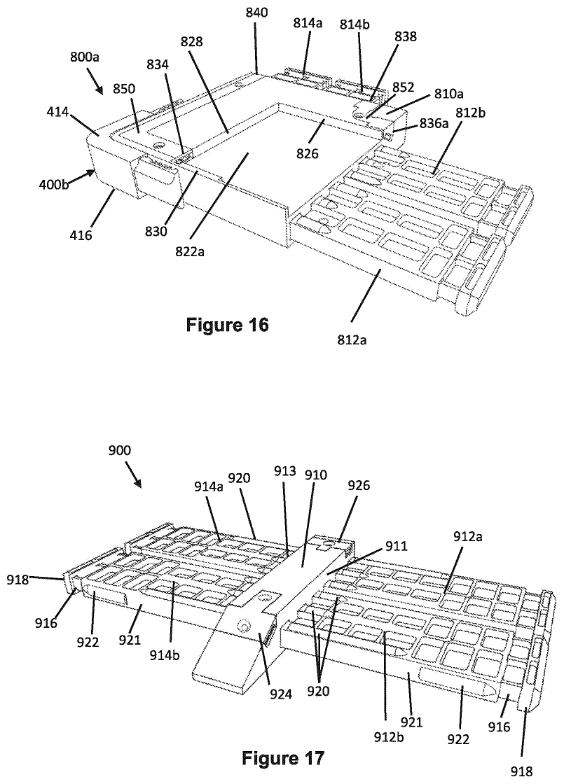

The relative position of the recess 822 means that the corner spacer portion 800 forms a “right hand” corner spacer portion configured to positioned on one side of a window unit. In the “right hand” configuration, the recess 822 is positioned to the right of the first side second socket 836. Put another way, in the “right hand” configuration, the recess 822 is positioned along a right side of the body 810 such that the recess 822 runs along a right side of the body 810. Similarly, in the “right hand” configuration, the first socket 834 is positioned on a right side of the recess 822. FIG. 16 shows an embodiment of a “left hand” corner spacer portion 800a. Corner spacer portion 800a is a mirror image of corner spacer portion 800 where like features are described with like references. In corner spacer portion 800a the recess 822a is positioned on a left-hand side of the first socket 836a on the first side of the body 810a. Similarly, the first socket 834a is positioned on a left side of the recess 822a. The terms “left” and “right” used to describe locations of features relative the recess 822 is referenced against an insertion direction in which a solar cell is inserted into the recess 822. Unlike corner spacer portion 800, corner spacer portion 800a is provided with a spacer coupler in the form of non-electrical feedthrough 400b such that the second and third sockets 836a and 838b and electrically connected to one another by connector 852 and the first and fourth sockets 834 and 840 are electrically connected to one another with connector 850, similar to corner spacer portion 210 as described above. The non-electrical feedthrough 400b may use coupling projections 402a along with channel 412 similar to electrical feedthrough 400a.

The corner spacer portion 800 and corner spacer portion 800a form part of a spacer system where a combination of “right hand” and “left hand” spacer portions are used and positioned around a perimeter of a window unit. As the window unit only requires one electric feedthrough (e.g. 400, 400a) for connecting the window unit to an external electrical system, one corner of the window unit will have e.g. corner spacer portion 800 and the other three corners will have a corner spacer portion having non-electrical feedthrough 400b. It should be appreciated that either of the “right hand” and “left hand” orientations of the corner spacer portions have the electrical feedthrough 400/400a. For example, the spacer system would typically include four corner spacer portions comprising two “left hand” and two “right hand” corner spacer portions, with one of the corner spacer portions having electrical feedthrough 400/400a and the other three having non-electrical feedthrough 400b.

Depending on the size of the window unit, the elongated side support elements e.g. 212 may need to be coupled together in a daisy-chain manner to provide a sufficient span along an edge of a window panel that forms part of the window unit. Accordingly, in an embodiment, the spacer system also includes coupler 900. The coupler 900 will now be described with reference to FIG. 17.

Coupler 900 has a body 910 having a first side 911 and a second side 913 opposite the first side. Extending from the first side 911 is coupling portion 912 and extending from the second side 913 is coupling portion 914. In the embodiment shown in FIG. 17, the coupling portion 912 has first coupling portion 912a and second coupling portion 912b extending on one side of the body 910, and coupling portion 914 has first coupling portion 914a and second coupling portion 914b extending on a second side of the body 910. Separate elongated side support elements are configured to receive the coupling portion 912 or coupling portion 914 and be secured thereto. A longitudinal direction of the first coupling portion 912 and second coupling portion 914 are aligned such that when elongated side support elements are coupled to the first coupling portion 912 and second coupling portion 914 the respective elongated side support elements are aligned along a longitudinal direction.

The coupling portions 912 and 914 are each provided with elongate projections 920, which are similar to elongate projections 820. The elongate projections 920 are positioned on major faces of the coupling portions 912 and 914. Extending between the major faces are outer sides 921. Secondary elongate projections 922 are provided on the outer side 921. Although not shown in FIG. 17, the other outer side on e.g. coupling portion 912a may also be provided with the secondary elongate projections 922. The secondary elongate projections 922 form an interference fit with a side or lateral portions of an elongated side support element. Accordingly, the secondary elongate projections 922 help to laterally stabilise a connection between the elongated side support element and the body 910. This may be beneficial during manufacture of a window unit which is typically performed with the window unit orientated in a vertical direction. In such a vertical orientation, any lateral movement of the elongated side support element about the coupler 900 would result in the daisy-chained elongated side support elements not being linear. Therefore, the secondary elongate projections 922 help to axially align daisy-chained elongated side support elements during manufacture before sealants and adhesives are used to secure the components of the window unit together.

The coupler 900 also a first electrical connector 924 and a second electrical connector 926. The first electrical connector 924 and second electrical connector 926 are electrically isolated from one another. In use, a first solar cell abuts or comes into proximity of the first side 911 and a second solar cell abuts or comes into proximity of the second side 913. The first and second solar cell can be electrically connected to one another by electrically engaging with the first electrical connector 924 and/or the second electrical connector 926.

In a variation of the above-described embodiment one of the panels 202, 204 is replaced by a laminated structure comprising two parallel component panel portions. The two component panel portions are bonded together in a manner such that an airgap between the component panel portions is avoided. Series of solar cells are positioned between the two component panels and are oriented along edges of the two component panel portions. The series of solar cells are embedded within an adhesive material, such as polyvinylbutyral (PVB). The solar cells are bifacial and are arranged in an overlapping or “shingled” arrangement. The solar cells are electrically coupled to an electric component within the spacer portion 1100 and provide electricity of operation of the electrochromic coating. In this embodiment the spacer portion 1100 further comprises control electronic and a battery for storing generated electricity.

The above embodiments of the window unit 100 and window unit 200 may relate to a window unit used for vision glass or spandrel glass or cladding. Accordingly, the embodiments described above such as for sealing with the use of the texture on the top surface 418 and bottom surface 420 of the body 401 apply equally for vision glass and spandrel glass.

A person skilled in the art will appreciate that various modifications of the described embodiments are possible. For example, an edge area of the first panel 202 may extend beyond a projection of the circumference of the second panel 204 in a direction of a surface normal of the first panel 202.

Furter, in the above-described embodiments the corner spacer portion 109, 211 and 600 comprise the electric feedthrough. In a variation of the described embodiments one of the side spacer portions may instead comprise the electric feedthrough. In this case the side spacer portion comprising the electric feedthrough may be coupled to, or may form a part of, a side support element 212 and may be formed from a suitable polymeric material.

A person skilled in the art will appreciate that the prior art to which reference is made does not constitute an admission that the referenced prior art is part of the common general knowledge in Australia or another country.

In the claims that follow and in the preceding description, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the disclosure.

1. A window unit corner spacer for spacing apart first and second window panels in a window unit, the corner spacer comprising:
a corner spacer body having a recess that is dimensioned to receive a solar cell;
a first coupling portion and a second coupling portion each extending from the body, the first and second coupling portions configured to be received in and couple to an elongated side support that in use support one or more solar cells;
a first electrical connector positioned in the recess for electrically connecting the solar cell that is received in the recess to one or more electrical components; and
a spacer coupler coupled to or formed with the body, the spacer coupler configured to be received in and couple to one or more spacer portions that space apart the first and second window panels, wherein, in use, a primary seal that prevents transfer of a gaseous medium, such as air, if formed between at least the spacer coupler and the first and second window panels.

2. A window unit corner spacer of claim 1, wherein the spacer coupler has opposed sides that in use are each bonded to one of the first or second window panel, wherein the opposed sides are textured such that sealant applied to the texture bonds and flows similarly to sealant applied to the spacer portions.

3. A window unit corner spacer of claim 1, wherein the spacer coupler is provided with a spacer coupler body and coupling elements extending from the spacer coupler body, the coupling elements configured to be received in and couple to one of the spacer portions.

4. A window unit corner spacer of claim 3, wherein the coupling elements are coupleable to the spacer coupler body.

5. A window unit corner spacer of claim 4, wherein the coupling elements are provided with a dovetail pin and the spacer coupler body is provided with a channel having a complementary shape that can receive the dovetail pin such that an interference fit is formed therebetween to lock the dovetail pin and channel together.

6. (canceled)

7. (canceled)

8. (canceled)

9. (canceled)

10. (canceled)

11. (canceled)

12. (canceled)

13. (canceled)

14. (canceled)

15. A window unit corner spacer of claim 1, wherein the spacer coupler includes an electric feedthrough for directing electricity between at least a solar cell electrically connected to the first electrical connector and an electric component positioned outside the window unit, the electric feedthrough being sealed in a manner such that a transfer of a gaseous medium, such as air, through the corner spacer with the electric feedthrough is avoided.

16. A window unit corner spacer of claim 1, wherein the first electrical connector and a second electrical connector are arranged such that one or more solar cells associated with a first elongated side support engaged with the first coupling portion can engage with the first electrical connector and the second electrical connector; and
wherein a third electrical connector and a fourth electrical connector are arranged such that one or more solar cells associated with a second elongated side support engaged with the second coupling portion can engage with the third electrical connector and the fourth electrical connector.

17. A window corner spacer of claim 16, wherein the first electrical connector and the fourth electrical connector are electrically connected together and the second electrical connector and the third electrical connector are electrically connected together.

18. A window corner spacer of claim 16, wherein the first electrical connector and the second electrical connector are electrically connected together and to the electric feedthrough, and the third electrical connector and the fourth electrical connector are electrically connected together and to the electric feedthrough separate to the first electrical connector and the second electrical connector.

19. (canceled)

20. (canceled)

21. (canceled)

22. (canceled)

23. (canceled)

24. A window unit for a building or structure, the window unit comprising:
first and second panels each having an area transparent for at least a portion of visible light; and
a spacer structure positioned at least partially between the first and second panels, the spacer structure comprising elongated side spacer portions and corner spacer portions, the elongated side spacer portions and corner spacer portions together forming the spacer structure which surrounds a space between the first and second panels;
wherein at least one of the elongated side spacer portions and corner spacer portions comprises an electric feedthrough for directing electricity between a first electric component positioned outside the window unit and a second electric component positioned at or within the window unit, the at least one of the elongated side spacer portions and corner spacer portions with the electric feedthrough being sealed in a manner such that a transfer of a gaseous medium, such as air, through the at least one of the elongated side spacer portions and corner spacer portions with the electric feedthrough is avoided.

25. The window unit of claim 24 wherein at least one of the corner spacer portions comprises the electric feedthrough.

26. (canceled)

27. The window unit of claim 24 wherein the electric feedthrough is hermetically sealed in the at least one of the elongated side spacer portions and corner spacer portions comprising the electric feedthrough.

28. The window unit of claim 24 comprising a support structure for supporting solar cells.

29. The window unit of claim 28 wherein at least one of the corner spacer portions comprises the electric feedthrough, wherein the support structure comprises elongated side support elements which are coupled to the corner spacer portions using a suitable coupling, and wherein the elongated side spacer portions, coupled to the corner spacer portions, are separate from, coupled to or form part of respective elongated side support elements.

30. The window unit of claim 28 wherein at least one of the side spacer portions comprises the electric feedthrough, wherein the support structure comprises elongated side support elements which can be coupled to the corner spacer portions using a suitable coupling, wherein the elongated side spacer portions are separate from, coupled to or form part of respective elongated side support elements.

31. (canceled)

32. The window unit of claim 24 wherein the corner spacer portions and the elongated side spacer portions are arranged such that transmission of a gaseous medium, such as air, through the elongated side spacer portion and corner spacer portion is avoided when the elongated side spacer portion and corner spacer portion are coupled together.

33. (canceled)

34. (canceled)

35. The window unit of claim 24 wherein the first and second panels are coupled to the spacer structure using a sealing adhesive material and a layer of the sealing adhesive is applied over portions the spacer structure and edge portions of the first and second panels whereby a primary seal is formed and which seals an interior space of the window unit in a manner such that a transfer of a gaseous medium, such as air, the interior space is at least substantially avoided.

36. (canceled)

37. (canceled)

38. The window unit of claim 28 wherein the spacer structure and the support structure are positioned entirely between the first and second panels.

39. The window unit of claim 28 wherein the support structure and the of solar cells are positioned in strips along edges of the first panel and around a central rectangular area that is free from solar cells.

40. The window unit of claim 24 wherein the spacer structure is a first spacer structure, wherein the window unit comprises a second spacer structure and a third panel which is positioned parallel to the first and second panels and is spaced apart from the second panel by the second spacer structure.

41. (canceled)

42. (canceled)

43. (canceled)

44. (canceled)

45. (canceled)

46. (canceled)
